(19) United States
(12) Patent Application Publication
(10) Pub. No.: US 2012/0044371 A1
(43) Pub. Date: Feb. 23, 2012

(54) WIRELESS CAMERA SYSTEM BRIDGING METHODS AND APPARATUS

(76) Inventor: KEVIN J. KING, VANCOUVER, WA (US)

(21) Appl. No.: 13/212,988

(22) Filed: Aug. 18, 2011

Related U.S. Application Data
(60) Provisional application No. 61/375,023, filed on Aug. 18, 2010.
(60) Provisional application No. 61/375,231, filed on Aug. 19, 2010.
(60) Provisional application No. 61/380,213, filed on Sep. 4, 2010.

(51) Int. Cl. H04N 5/232

(52) U.S. Cl. 348/211.2; 348/E05.043

(57) ABSTRACT

Providing a radio bridge between primary and secondary camera systems employing incompatible wireless communication protocols (“WCPs”) includes receiving a radio signal from a primary system device, identifying an associated operational command for another primary system device, formatting a command signal conveying the operational command according to the secondary system WCP, and transmitting the command signal to a secondary system device. Optionally, a communication link is established between a primary system device and a non-participant device, by identifying the non-participant device to the primary system device as another primary system device. A bridging apparatus includes a first radio to receive radio signals formatted according to the primary system WCP, and circuitry to associate a received signal with a primary system operational command, format a command signal conveying the operational command, and cause a second radio employing the secondary system WCP to transmit the command signal to a secondary system device.

### RELATED APPLICATIONS

This application claims the benefit of the following U.S. Provisional Applications, the entire disclosures of which are incorporated herein by reference for all purposes: Ser. No. 61/375,023, filed Aug. 18, 2010; Ser. No. 61/375,231, filed Aug. 19, 2010; and Ser. No. 61/380,213, filed Sep. 4, 2010.

### TECHNICAL FIELD

This disclosure relates to control of camera system devices, and in particular to methods and apparatus for bridging or otherwise facilitating wireless communications and operations among photographic devices and/or camera systems employing mutually incompatible wireless communication protocols.

### BACKGROUND

It has been long recognized that communication methods other than by means of directly wired connections have utility and offer advantages in many settings. In a camera system, for example, optical communication, usually in the form of pulses of IR or visible light, enable photographic devices of the camera system to communicate and, if desired, to synchronize operation, without the use of cables or other means of directly connecting the devices to each other. In a standard example, a camera may instruct a remote flash unit to emit light for a pre-flash operation and/or during image acquisition by the camera, by means of operational commands encoded in sequences of optical pulses emitted by the camera and received by the flash unit.

Although it has become conventional for photographic devices to employ optical communication, this approach has limitations, however, such as in shooting conditions in which the ambient lighting, reflective surfaces, weather conditions, and so forth, may interfere with reliable receipt of pulsed optical data. As such, wireless communication systems, i.e. communication systems using radio waves, have been developed for use with conventional camera systems that employ optical means of communication. For example, methods, systems, and devices employing wireless communication for conventional camera systems, such as to establish, facilitate, and maintain wireless communication among various photographic devices of a camera system, to prepare and activate flash units by radio, and so forth, are disclosed in Applicant's co-pending U.S. Patent Application Pub. Nos. US2009012975, US20100008658, US20100124412, US20100158494, and US20100209089, the complete disclosures of which are hereby incorporated by reference. One or more of the aforementioned publications disclose various examples of external wireless communication devices that may be used to retrofit conventional (i.e. non-wireless) photographic devices with wireless functionality.

Recently, photographic equipment has been developed that integrates wireless functionality into photographic devices. The term “wireless-enabled” is used herein to refer to a photographic device, such as a camera, a flash unit or device, a light metering device, and so forth, that integrally incorporates wireless reception and/or transmission means (and to distinguish, the term “non-wireless,” as used herein, refers to photographic devices that do not incorporate wireless functionality). For example, U.S. Patent Application Pub. No. 20100202767 of Shirakawa discloses a wireless camera system that includes a camera and a flash unit both having built-in wireless capability. In the Shirakawa camera system, the wireless-enabled camera wirelessly communicates with the wireless-enabled flash unit according to a protocol such as the IEEE 802.15.4 wireless communication standard.

As used herein, the term “protocol,” and more specifically the term “wireless communication protocol” (or “WCP”) refer to a set of message formats, and rules for wirelessly exchanging such messages (i.e., by means of radio signals), such as specifying various communication parameters such as radio frequency or frequency range used, data transmission rate, data format, command code format, modulation timing and/or format, and so forth. As such, a wireless communication protocol may incorporate one or more wireless communication standards (such as WiFi, which employes the IEEE 802.11 family of standards), may further refine one or more standards (such as the ZigBee specification, which specifies layers not defined in IEEE 802.15.4), and further may be proprietary to a particular manufacturer, such as may be developed to specifically work with a proprietary communications standard.

Typically, different wireless communication protocols are inconsistent or otherwise incompatible with each other due to the different parameters employed by different protocols, such that a radio signal formatted according to a first wireless communication protocol may not be decipherable to, or even detectible by, a receiving component employing a second wireless communication protocol. Indeed, manufacturers may exclusively employ a proprietary wireless communication protocol in their equipment in order to leverage a market advantage. As such, although wireless camera communication may offer advantages over other forms of camera communication, the existence of several mutually incompatible wireless communication protocols in camera systems presents a substantial obstacle to the integration of photographic devices employing different protocols into a single wireless camera system. For example, a photographer who has purchased a wireless-enabled camera unit and compatible wireless-enabled flash may wish to use a studio lighting unit that has been retrofitted with wireless capability via an external wireless communication device, only to find that the wireless communication protocol employed by the wireless communication device is incompatible with that employed by the wireless-enabled camera and flash.

### SUMMARY

The methods and apparatus disclosed herein may facilitate bridging or otherwise wirelessly interconnecting photographic devices, and/or wireless camera systems that each include one or more photographic devices, employing mutually incompatible wireless communication protocols.

In a first illustrative method, in accordance with the present disclosure, for providing a radio bridge between first and second camera systems employing mutually incompatible first and second wireless communication protocols, one or more radio signals transmitted by a source device of a first camera system, and formatted according to a first wireless communication protocol, may be received. An operational command associated with the received signal or signals, for a participant device of the first camera system, may be identified. The method may proceed by formatting, according to the second wireless communication protocol, a radio command signal conveying the operational command, and transmitting the radio command signal to a participant device of the second camera system. In some examples, the associated operational command may be conveyed in a received radio signal, in which case the operational command may simply be read from the radio signal, whereas in other examples, the associated operational command may be identified from a radio signal that precedes the subsequent issuance of the operational command, such as by a characteristic time interval.

An example of an operational command conveyed in a radio signal is an emission instruction signal transmitted, for example, from a wireless-enabled camera to a wireless-enabled flash, instructing the emission of light from the flash. Typically, an emission instruction signal is transmitted in advance of an operation by the camera, such as an image acquisition operation. Accordingly, an emission instruction signal may be configured to synchronize the instructed flash emission with the image acquisition (or other) operation of the camera, such as by including timing information relating to a point in time when the camera operation will be performed. In such an example, identifying the operational command may include reading the timing information. The illustrative method may thus further include calculating, based on the timing information, appropriate timing for transmitting the radio command signal so that the operation commanded will be performed by the participant device of the second camera system according to the timing information.

An example of a signal that precedes the subsequent transmission of an operational command is a signal indicating that a shutter button of a camera, such as a wireless-enabled camera, has been fully pressed (also referred to herein as a SW2 signal). In many camera systems, a SW2 or analogous signal is then followed, after a known time interval, by an operational command transmitted by the camera calling for a pre-flash emission from the flash. In such an example, identifying the operational command (in this case, the call for the pre-flash emission) may be accomplished by recognizing the signal as a SW2 signal. The illustrative method may thus further include calculating, based on the known time interval, appropriate timing for transmitting the radio command signal so that the operation commanded will be performed by the participant device of the second camera system at an appropriate time.

In a second illustrative method, in accordance with the present disclosure, for providing a radio bridge, a communication link may be established between a first participant device of a first camera system that employs a first wireless communication protocol and a communication device (such as a bridging apparatus as disclosed herein) that is a non-participant of the first camera system, by identifying the communication device to the first participant device as a second participant device of the first camera system. In some examples, this may be accomplished by the communication device transmitting a radio signal, according to the first wireless communication protocol, to the first participant device, conveying identifying information that would be provided by a second participant device. The second illustrative method may proceed by receiving, by the communication device, one or more radio signals transmitted by the first participant device and formatted according to the first wireless communication protocol, and identifying, from the one or more received radio signals, an associated operational command for the second participant device. A radio command signal conveying the operational command may then be formatted according to a second wireless communication protocol mutually incompatible with the first wireless communication protocol, and the second illustrative method may then continue by transmitting, by the communication device, the radio command signal to a participant device of a second camera system that employs the second wireless communication protocol.

In some examples, the participant device of the second camera system is a wireless-enabled photographic device, such as a wireless-enabled camera or a wireless-enabled flash, such as disclosed in US20100202767 of Shirakawa. In other examples, the participant device of the second camera system is a non-wireless photographic device that is otherwise provided wireless capability, such as by means of a wireless-enabled communication device configured to communicate with the non-wireless photographic device, such as disclosed in one or more of Applicant's aforementioned US2009012975, US20100008658, US20100124412, US20100158494, and US20100209089.

The aforementioned illustrative methods may be accomplished using various suitable components and devices as discussed herein. An illustrative example configuration of such a component, constructed in accordance with aspects of the present disclosure, may be in the form of a communication device constructed in accordance with the present disclosure for use with a camera system, and may include a first radio module configured to receive radio signals formatted according to a first wireless communication protocol and transmitted by a source device of a first camera system that employs the first wireless communication protocol, and circuitry adapted to associate one or more received radio signals with a corresponding operational command for a participant device of the first camera system, to format, according to a second wireless communication protocol incompatible with the first wireless communication protocol, a radio command signal conveying the operational command, and to cause a second radio module compatible with the second wireless communication protocol to transmit the radio command signal to a participant device of a second camera system that employs the second wireless communication protocol. In some embodiments, the communication device includes the second radio module. In some embodiments, the communication device includes a port configured to couple with a second radio module. In some embodiments, the first radio module is further configured to transmit radio signals according to the first wireless communication protocol. Optionally, in such embodiments, the circuitry may be further adapted to format, according to the first wireless communication protocol, a radio identification signal identifying the communication device as a participant device of the first camera system, and to cause the first radio module to transmit the radio identification signal to the source device.

The concepts, features, methods, and component configurations briefly described above are clarified with reference to the accompanying drawings and detailed description below.

### BRIEF DESCRIPTION OF THE DRAWINGS

FIG. 1 shows a schematic view of an example photographic setup in which a first camera system includes a camera and a remote flash device and employs a first wireless communication protocol, and in which an illustrative embodiment of a bridging apparatus configured in accordance with aspects of the present disclosure is used with photographic devices of other camera systems employing other wireless communication protocols that are mutually incompatible with the first wireless communication protocol.

FIG. 2 is a schematic view illustrating the internal layout of various components of the bridging apparatus of FIG. 1.

FIG. 3 is a timing chart illustrating an example synchronization sequence utilized in a wireless camera system such as that shown in FIG. 1.

FIG. 4 is a timing chart illustrating example timing of a sequence of emitting instruction signals transmitted by a camera of a wireless camera system, and radio command signals transmitted by a bridging apparatus.

FIG. 5 is an example packet data structure of an emitting instruction signal such as used in the timing chart of FIG. 3.

FIG. 6 is a timing chart showing, in detail, an example synchronization sequence in response to receiving an emitting instruction signal.

FIG. 7 is a timing chart showing various example communications and operations by and among a bridging apparatus and participant devices of primary and secondary camera systems.

FIG. 8 is a timing chart showing another example synchronization sequence utilized in a wireless camera system such as that shown in FIG. 1.

FIG. 9 is a schematic diagram illustrating a variety of example connections and communications that may be achieved with a bridging device configured in accordance with aspects of the present disclosure.

FIG. 10 shows a schematic view of a second example photographic setup in which a bridging device configured in accordance with aspects of the present disclosure is employed to facilitate wireless communications between two camera systems employing mutually incompatible wireless communication protocols.

FIG. 11 shows a schematic view of a third example photographic setup in which a bridging device configured in accordance with aspects of the present disclosure is employed to facilitate wireless communications between two camera systems employing mutually incompatible wireless communication protocols.

FIG. 12 is a timing chart showing various example communications and operations by and among the bridging apparatus and the participant devices of the two camera systems of FIG. 11.

### DETAILED DESCRIPTION

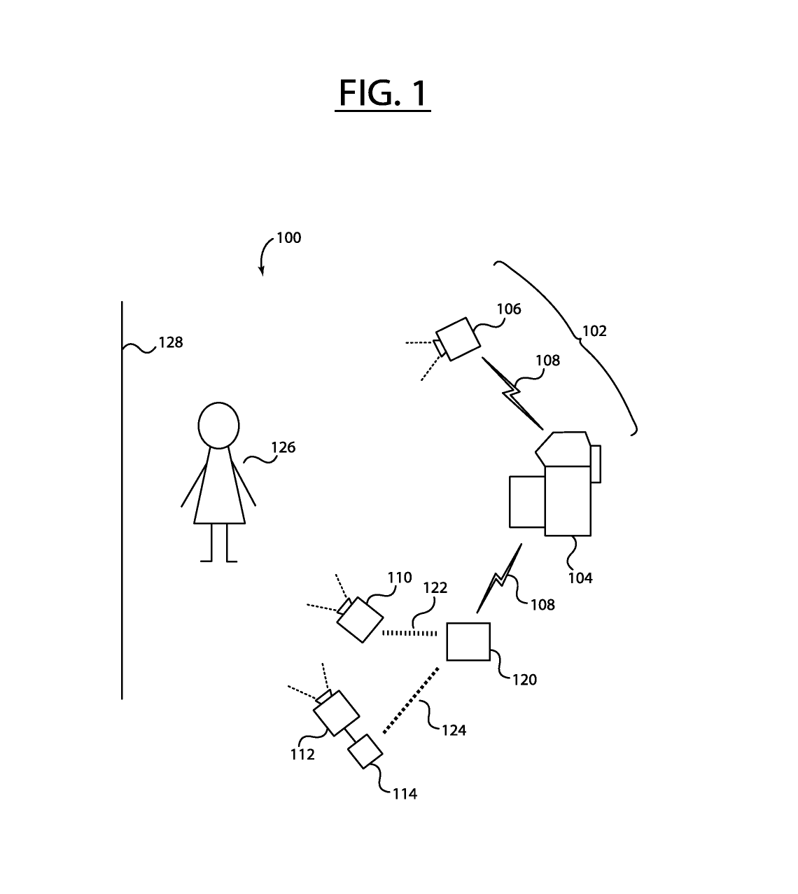

FIG. 1 is a schematic view illustrating an example photographic setup, designated generally as 100, in which a first camera system 102 is shown to include a wireless-enabled camera 104 and a wireless-enabled flash device 106 set up remotely from the camera, with which the camera is configured to wireless communicate by means of wireless (i.e. radio) communication signals. More specifically, in camera system 102, camera 104 controls the operation of flash device 106 by means of wireless communication signals. As such, the camera 104 (or similar photographic device that provides instruction signals) may be referred to herein as a master device, or source device, whereas the flash device 106 (or similar photographic device that follows the provided instruction signals) may be referred to as a slave device. In some wireless camera systems, for example those that may include multiple cameras, one camera may be designated as a master device to which the other cameras, as well as one or more flash devices of the camera system, are slaved. Some wireless camera systems may include multiple master devices, and/or devices that are master to some and slave to another, and so forth.

The wireless-enabled photographic devices of camera system 102 may be configured as disclosed, for example, in US20100202767 of Shirakawa, the complete disclosure of which is hereby incorporated by reference. For example, wireless-enabled camera 104 and wireless-enabled flash device 106 may each include, in addition to the various optical, mechanical, and electrical components to perform photographic imaging and/or flash emission, a wireless antenna operated by a wireless communication circuit, such that the wireless-enabled photographic devices may communicate via wireless communication signals.

The wireless communications by which the wireless-enabled participant devices of camera system 102 communicate may be formatted according to a suitable wireless communication protocol that is employed by all of the participant devices of the camera system. Using the above example, US20100202767 of Shirakawa explains that the wireless-enabled devices disclosed therein employ a protocol such as the IEEE 802.15.4 wireless communication standard. However, the wireless-enabled devices of Shirakawa may employ a different wireless communication protocol, such as WiFi, another 802.11-based protocol, Zigbee or another WPAN or similar protocol, a proprietary protocol, modifications thereof, a protocol combining different aspects of known protocols, protocols that may yet be developed, and so forth. Such a wireless communication protocol, also referred to herein as a WCP, may specify the parameters by which the wireless communications are formatted in order to be properly transmitted, received, and understood by the participant devices of the camera system employing the WCP in a manner that allows reliable operation and/or co-operation of the various participant devices. As such, communications not formatted according to a given WCP may not be understood, or even detectible, by participant devices employing the WCP. The wireless communications by which the wireless-enabled participant devices of camera system 102 communicate are shown at 108, and indicate communications formatted according to a first wireless communication protocol.

Photographic setup 100 is also shown to include a second wireless-enabled flash device 110, and a non-wireless flash device 112, which is shown to be retrofitted for wireless capability with a wireless communication device 114. The flash devices 110, 112 may represent any suitable type of photographic lighting device capable of emitting photographic illumination, such as a studio monolight (for example, a Photogenic PL1250), an electronic flash unit (for example, a Canon Speedlite 430EX), and so forth. Wireless communication device 114 may be any suitable device configured to receive wireless camera commands and relay and/or transform such signals into signals perceptible to a non-wireless photographic device. Several examples of such devices are disclosed in Applicant's aforementioned US2009012975, US20100008658, US20100124412, US20100158494, and US20100209089.

As noted above, non-wireless photographic devices may be configured for communication in various ways, the two main ways being via a direct electrical connection, such as by means of a cord, cable, hotshoe connection, and so forth, and via optical communications. As such, although wireless communication device 114 is shown to be directly coupled to the flash device 112 via a cord, communication between wireless communication device 114 and flash device 112 may not require a direct connection.

However, although the flash devices are both shown to have wireless capability, either built-in (in flash device 110) or external (in flash device 112), the devices may be configured to employ a wireless communication protocol that is incompatible with that employed by the participant devices of camera system 102, for example due to one or more inconsistent communication parameters (bit rate, frequency or frequency range, signal/command format, signal/command sequence, etc.) between the WCPs used. For example, the first WCP may operate at a radio frequency of 2.4 GHz, or 5 GHz, and so forth, whereas the wireless flash device 110 employs a WCP that operates in a different radio frequency, such as a frequency in the range of 902 to 928 MHz. Moreover, the WCPs used by the flash devices 110 and 112 may be mutually incompatible with each other as well as with the first WCP employed by the camera system 102. To continue the radio frequency example, the flash device 112, via wireless communication device 114, may employ a WCP that operates at a radio frequency around 344 MHz.

FIG. 1 is also shown to include a bridging apparatus 120. As explained in greater detail herein, bridging apparatus 120 is a specialized communication device that may be configured to provide a radio bridge between camera systems employing mutually incompatible wireless communication protocols in order to facilitate communications among such systems. Accordingly, bridging apparatus may receive radio signals from a source device of a first camera system, such as camera 104 of camera system 102, that are formatted according to a first WCP, and transmit radio signals to other camera systems (or, more specifically, to participant devices thereof) that are formatted according to the WCP(s) employed by such other camera systems. For example, bridging apparatus 120 is shown to receive a radio signal 108 from camera 104 and formatted according to the first WCP, and is also shown to transmit a second radio signal 122 that is formatted according to a second WCP employed by wireless-enabled flash device 110, and a third radio signal 124 that is formatted according to a third WCP employed by wireless communication device 114.

In such a manner, bridging apparatus 120 may be used to coordinate photographic operations of a number of different photographic devices. In one example, bridging apparatus 120 may be employed in order to synchronize emission of light from one or both of flash devices 110, 112 with image acquisition, such as of a subject 126 against background 128, by camera 104. In another example, bridging apparatus 120 may be employed in order to order pre-flash emissions from one or both of flash devices 110, 112 coincident with one or more pre-flash operations of camera 104. Example methods that may be employed to accomplish these and other actions are explained in detail below.

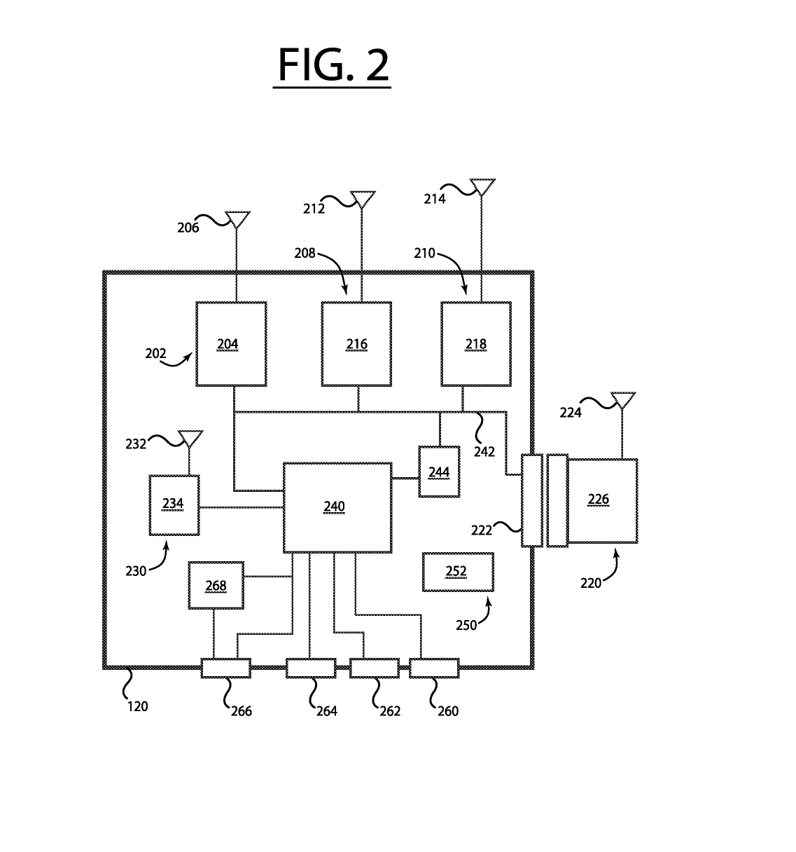

FIG. 2 is a schematic view illustrating an example internal layout of bridging apparatus 120, which is shown to house a number of components in a housing 200. For example, bridging apparatus includes a first radio module 202 configured to receive and/or transmit radio signals formatted according to a wireless communication protocol, such as the first wireless communication protocol employed by camera system 102 of FIG. 1. As such, radio module 202 includes an antenna element 204, which may be internal or external to housing 200, that is matched to a radio frequency or frequency range used by the wireless communication protocol employed by the radio module 202, and radio circuitry 206 to operate the antenna element, pass electrical signals between the antenna element and other components of the apparatus 120, and so forth. Herein, a “radio module” may be referred to simply as a “radio.” An appropriate radio module 202 may be a CC1101 radio module commercially available from Texas Instruments, Inc. Although not specifically shown in this view, radio module 202 may further include various filtering, electrostatic discharge, and/or other components as suitable for the operation thereof, etc. For example, radio module 202 may include or be connected to a clocking source such as a crystal oscillator. Examples of appropriate construction, selection, and arrangement of radio circuitry and/or radio modules are disclosed in Applicant's US2009012975 and US20100209089, as well as in U.S. Pat. No. 5,359,375 to Clark, the complete disclosure of which is hereby incorporated by reference. In the example bridging apparatus 120, the wireless communication protocol employed by first radio module 202 is the first wireless communication protocol employed by camera system 102 in FIG. 1. As such, the antenna element 204 is matched to the frequency or frequency range employed by the first WCP, such as a frequency of 2.4 GHz, 5 GHz, or at any other radio frequency suitable for reception and/or transmission of signals formatted according to the first WCP, and the radio circuitry is adapted to process such signals. The choice of the WCP employed by the radio module 202 may be made by a manufacturer of bridging apparatus 120, as appropriate to enable the bridging apparatus available for use with known photographic devices that employ the WCP.

Although not required to all embodiments, bridging apparatus 120 is further shown to include additional radio modules each configured to operate according to a different WCP. For example, a second radio module 208, and a third radio module 210, may be physically configured similar to first radio module 202, in that the radio modules 208, 210 are shown to include respective antenna elements 212, 214 connected to and driven by respective radio circuitry 216, 218, but adapted to operate using one or more parameters (such as radio frequency, protocol, modulation format, data rate, etc.) that are inconsistent or otherwise incompatible with the first WCP employed by the first radio module 202. For the sake of clarity, the WCP by which the second radio module 208 is adapted to operate may be referred to as a second WCP, the third radio module 210 with a third WCP, and so forth. The antenna elements of the second and third radio modules are thus matched to the frequency or frequency range suitable for use with the respective WCP employed by the radio modules. For example, second radio module 208 may operate at a radio frequency in the range of 902 MHz to 928 MHz, and/or in a range of 865 MHz to 870 MHz, or at any radio frequency as consistent with the second WCP, such as chosen by a manufacturer of bridging apparatus 120. Similarly, third radio module may operate at yet another radio frequency range, such as 344 MHz, etc., as consistent with the third WCP.

Although not required to all embodiments, bridging apparatus 120 is further shown to be communicate with a fourth radio module 220, which is shown to be external to bridging apparatus 120. The communication may be accomplished such as via a removable connection shown as port 222. Fourth radio module may be somewhat similarly configured to radio modules 204, 208, and 210, in that it may include an antenna element 224 connected to radio circuitry 226, but may be adapted to operate according to a fourth WCP. As noted below, bridging apparatus 120 may be configured to recognize the WCP employed by a radio module connected thereto via port 22, such as to expand the range of WCPs with which the bridging apparatus may be used.

Along these lines, bridging apparatus may, but is not required, to include additional radio modules adapted to operate according to parameters (such as frequency, signal format, modulation, etc.) so as to communicate with or otherwise interact with any WCP. For example, bridging apparatus 120 is shown to include a fifth radio module 230 adapted to operate according to a wireless internet format such as WiFi, BlueTooth, etc., and provided with an appropriate antenna element 232, radio circuitry 234, and so forth, as suitable.

The terms “first,” “second,” “third,” and so forth, do not represent an order or preference, as the terms are simply used to distinguish one component from another component that may be similarly configured. As such, in the disclosure below, which often refers to a “first radio module” and a “first WCP,” such terms do not necessarily refer to a particular radio module or a particular WCP. For example, when referring to a primary system, such a camera system may employ a WiFi or similar WCP, and the “first radio module” employed by a bridging apparatus to communicate with such a camera system may be one that is configured to communicate according to the same WCP (in this example, WiFi or a similar WCP). In other examples, the “first radio module” (or, indeed, any radio module) may instead be configured to communicate according to a WCP that is incompatible with, or even much different than, a WiFi or similar WCP.

Bridging apparatus 120 includes a processing means 240, to which the various radio modules (and/or port 222) are shown to be connected via a data bus 242, which may be a serial peripheral (“SPI”) bus, an SSI bus, or other bus or signaling method as appropriate. Examples of processing means suitable for use in bridging apparatus 120 are disclosed in Applicant's US20100209089 and US20100158494. For example, an appropriate processing means may be a Microchip PIC1845K20, commercially available from Microchip, Inc. An alternate processing means, which in some cases may provide faster and more efficient operation, may be an LM3S9B95 Microcontroller, produced by Luminary Micro, Inc., which may be designed around an ARM Cortex-M3 processing core to enable robust operation, fast response to interrupt service routines, and the like. Processing means 240 may also include or be connected to a clocking source such as a crystal clocking oscillator, and so forth. As noted above, one or more radio modules may also include a clocking source, and thus in some embodiments a bridging apparatus may include multiple clocking sources, or may be configured to allow multiple components to use the same clocking source, and so forth. Of course, processing means may include multiple processors arranged in a parallel processing configuration, or a single, central processing unit (CPU), as desired.

Processing means 240 may incorporate or may otherwise communicate with a memory 244. For example, processing means may be programmable to execute instructions stored in memory 244. Memory 244 may include memory local to the device 120 as well as removable memory such as an SD memory card, a flash memory device, and the like, and may include read-only memory (ROM), such as EEPROM, etc., and/or random access memory (RAM). A basic input/output system (BIOS) may be stored in ROM, such as may contain the basic routines to transfer information among elements of the device, such as via bus 216 and various other signal lines and/or via a printed circuit board (PCB), according to known methods of circuit design. Memory 244 may provide nonvolatile storage for processor-readable instructions, data structures, program modules, a means for firmware updates for processing means 240, and other data (such as, but not limited to, image files, video files, music files, and so forth) for use by the bridging apparatus 120.

The bridging apparatus may further include a power source 250, such as an internal power source in the form of a battery 252, or may be externally powered, such as a conventional AC power cord, a USB cable, and so forth. Further, although not required to all embodiments, the bridging apparatus may be adapted to transmit information and other data by means of one or more data ports or connection interfaces. For example, bridging apparatus 120 is shown to include a hotshoe connector 260, for example to mate with (and communicate via electrical signals over) a corresponding hotshoe connector on a photographic device such as a camera or a flash unit, a USB port 262, which may be adapted to operate in any suitable USB mode including a host mode, a device mode, an on-the-go mode, etc., a synchronization port 264, which may be configured to send a signal to a photographic device to carry out a process, an NV port 266 capable of transmitting one or more of a video and an audio signal, and as such may be configured as an HDMI port, a video port configured according to various standards such as component video, RGB, DVI, VGA, etc. Optionally, bridging apparatus 120 may include an additional processing unit, such as a graphics processing unit (GPU) 268 to format and feed an appropriate signal to NV port 266.

Although not specifically shown, bridging apparatus 120 may include various filtering, electrostatic discharge, and other components, such as various resistors, capacitors, transistors, regulators, clocking elements, data bus lines, signaling lines, and so forth, as known in the art of electronic circuit design. Of course, other embodiments of a bridging apparatus constructed according to the present disclosure may include a greater or lesser quantity of any such component than as discussed above with respect to the example embodiment shown in FIG. 2. For example, a comparatively simpler embodiment than as illustrated may include a single radio module adapted to receive radio signals formatted according to a first WCP, such as transmitted by a source device of a camera system employing the first WCP, and circuitry adapted to associate a received signal with an operational command, format a radio command signal conveying the operational command according to a second WCP that is incompatible with the first WCP, and cause a second radio module compatible with the second WCP (for example, an external radio module removably coupled to the bridging apparatus, such as via a suitable port) to transmit the radio command signal, such as to a participant device that employs the second WCP.

The physical form of the bridging apparatus is not particularly limited and may be designed as suitable for its use. In embodiments in which the functional components are more or less self-contained in the same housing, the bridging apparatus may be placed proximate to or arranged within the physical environment in which the photographic devices employing mutually incompatible WCPs are to be used, such that the various photographic devices are within signaling range of the apparatus, such as shown in photographic setup 100 of FIG. 1. It is considered that the bridging apparatus may be physically configured to be worn on a belt clip or lanyard, etc., of a photographer, attached to a tripod in use in the photographic environment, placed behind another piece of photographic equipment, attached to an electrical outlet from which it may draw power, or, if battery-powered, switched on and simply left in a gear bag while a photographic session is being carried out, and so forth. In other embodiments, the bridging apparatus may be housed partially or completely within another piece of photographic equipment, connected thereto such as via a hotshoe connector, etc. In still other embodiments, various components of the bridging apparatus may be separately located, and as such may be placed near, contained or otherwise incorporated in, or connected to, one or more photographic devices.

The following illustrative examples demonstrate various ways of using a bridging apparatus in accordance with the present disclosure with a wireless camera system that employs a first wireless communication protocol and one or more photographic devices that employ one or more mutually incompatible wireless communication protocols. As used herein, the terms “wireless camera system” and “camera system” refer to one or more photographic devices that are configured to wirelessly communicate, such as via integral wireless capability or retrofitted wireless capability, according to the same wireless communication protocol. Photographic devices of a wireless camera system are referred to as “participant devices” thereof. For example, in FIG. 1, camera 104 and flash device 106 may be participant devices of a camera system that both employ the same WCP. Wireless-enabled flash device 110 may be a participant device of another camera system (in this case, one that includes only flash device 110) that employs a different WCP. Non-wireless flash device 112, via wireless communication device 114, is a participant device of yet another camera system, and so forth.

Briefly, in the illustrative examples, a first radio module of the bridging apparatus receives one or more radio signals transmitted by a source device (such as a camera) of a first camera system formatted according to a first wireless communication protocol. The first radio module and/or the processing means of the bridging apparatus identify from the received signals an associated operational command for a participant device (such as a flash device) of the first camera system. In some cases, the associated operational command may be an actual operational command contained in the received signals; in others, the associated operational command may be one that characteristically follows one of the received signals, generally by a known interval of time. Once the operational command is identified, the bridging apparatus, such as via the processing means (optionally in coordination with a second radio module of the bridging apparatus) formats a radio command according to a second wireless communication protocol employed by a participant device of a second camera system. The radio command signal is then transmitted to the participant device of the second camera system.

Of course, the bridging apparatus, such as via additional radio modules, may also or alternatively format one or more signals to be transmitted to participant devices of a third camera system, a fourth, and so on. For the sake of clarity, in the disclosure herein, the first camera system is sometimes referred to as the “primary system,” such as when a participant device of the first camera system is the one that originates the signal prompting a sequence of events being discussed, whereas the camera system to which a corresponding or otherwise related signal or communication is being directed, such as by the bridging device, is sometimes referred to herein as a “secondary system.”

A first illustrative example of using a bridging apparatus may be understood with reference to FIG. 1, in which bridging apparatus device 120 is used to communicate participant devices of camera system 102, which employ a first WCP, with flash devices 110, 112, which employ respectively employ mutually incompatible WCPs. In this example, a first radio module 204 of the bridging apparatus 120 may begin receiving radio signals 108 that are formatted according to the first WCP, as transmitted by camera 104. One of the signals may be an emission instruction signal or other type of flash instruction transmitted by the camera 104 in advance of performing an image acquisition operation, which includes timing information for the performance of the operation, such as a predetermined time at which the operation will occur, a time interval following the emission instruction signal after which the operation will occur, and so forth. The processing means of the bridging apparatus identifies the received signal as an emission instruction signal, and formats, according to a second WCP employed by wireless flash device 110, a radio command conveying the emission instruction signal. The bridging apparatus then transmits the radio command (shown as 122) to the wireless flash device 110, according to timing calculated in order to synchronize the emission of light from the flash device 110 with the image acquisition operation of camera 104. Additionally or alternatively, the bridging apparatus may format, according to a third WCP employed by wireless communication device 114, another radio command conveying the emission instruction signal, and transmit the radio command (shown as 124) to the wireless communication device 114, according to timing calculated to synchronize emission with image acquisition (which may consider any time required for the wireless communication device 114 to relay the command to flash device 112).

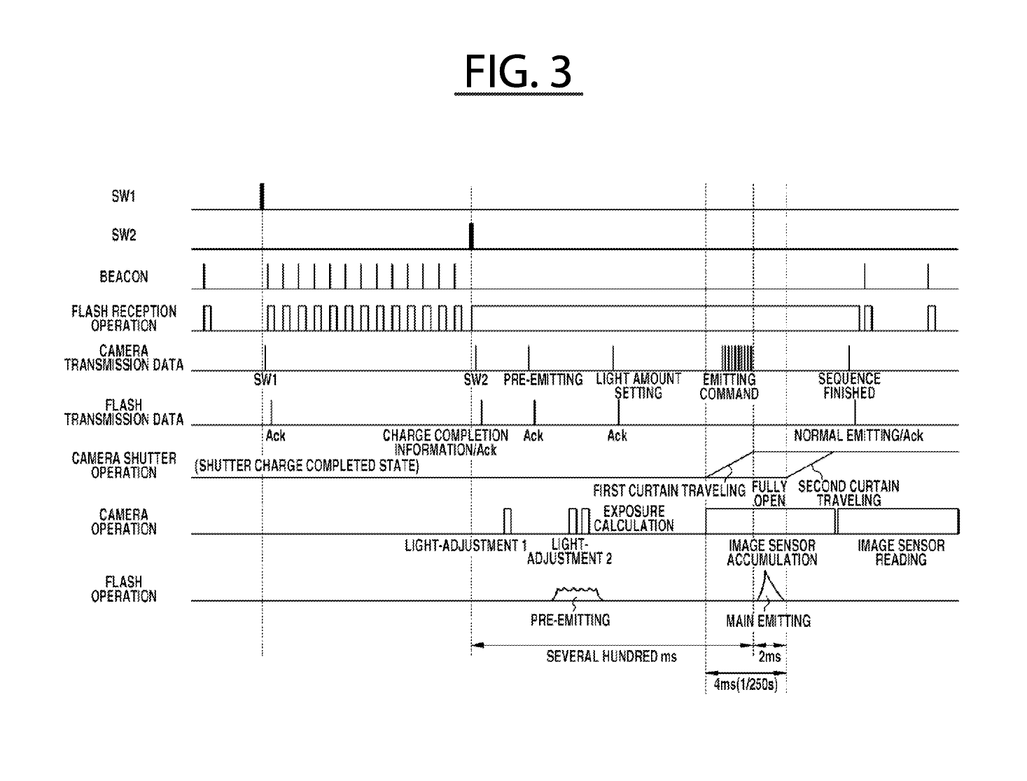

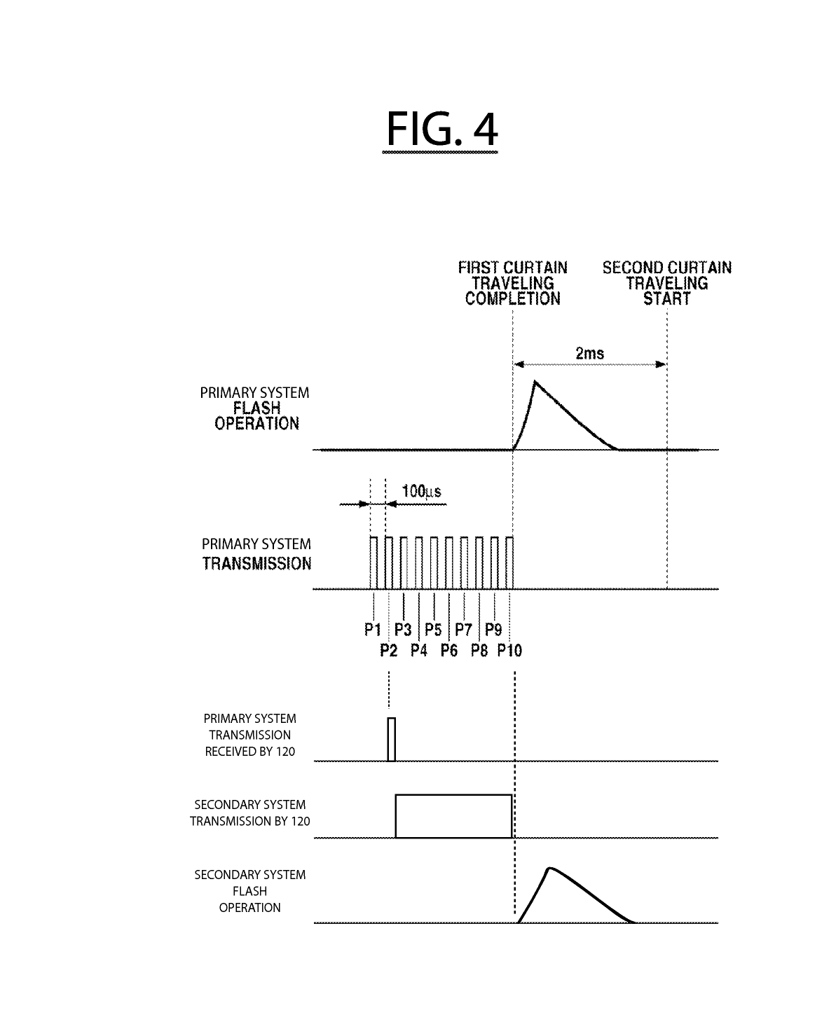

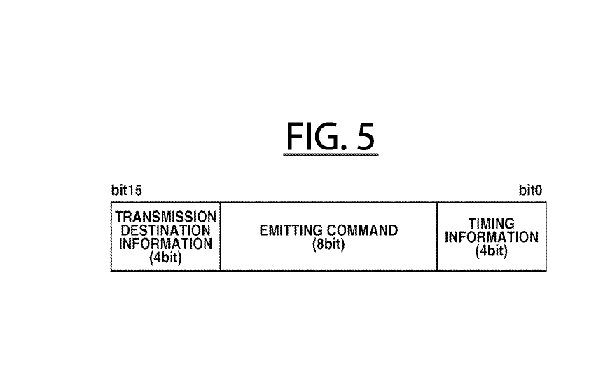

US20100202767 of Shirakawa discloses an example of a wireless camera system in which a wireless-enabled camera issues a sequence of wireless emitting instruction signals in advance of opening its shutter for image acquisition. FIG. 3 shows an example timing chart showing various wireless communications and photographic operations that may occur in such a wireless camera system. On the “camera transmission data” line of the timing chart, a sequence of ten emitting instruction signals (captioned as “emitting commands”) is shown to be wirelessly transmitted by the camera as the first curtain of the camera shutter travels to an open state. FIG. 4 shows a detail of this chart, illustrating in greater detail an example of the timing of the emitting instruction signal sequence P1, P2, . . . , P10, and FIG. 5 shows an example packet data structure of a single emitting instruction signal. As explained in the Shirakawa disclosure, the timing information of each emitting instruction signal may indicate the time until image acquisition by the camera will occur, and thus the timing information of each emitting instruction signal will be different depending on its place in the sequence. For example, if the emitting instruction signals are transmitted every 100 microseconds, the timing information that represents the time until image acquisition will occur in emitting instruction signals in the sequence will decrease incrementally by 100 microseconds as the sequence proceeds from P1 to P10. Such an emitting instruction signal may thus be recognized as such, when received by the receiving component of a bridging apparatus, by the emitting command data and/or the timing information data in the packet comprising the emitting instruction signal. In such an example, once an emitting instruction signal is received and identified as such, the processing means of the bridging apparatus may be configured to simply ignore subsequent emitting instruction signals in the sequence, or indeed any other signals relating to the same photographic operation.

An example timing sequence similar the above is shown in FIG. 4, in which the sequence of emitting instruction signals P1, P2, . . . , P10, is shown on the “primary system transmission” line. In this example timing sequence, emitting instruction signal P2 is received by the bridging apparatus 120, which responds as shown on the “secondary system transmission by 120” line by transmitting a signal, such as radio command 124, to flash device 110. This results, on the “second camera system flash operation” line, in a flash operation by the flash device 110 that is synchronized with the open shutter of the camera, and also with the flash emission by the flash device of the first camera system (as shown on the “primary system flash operation” line). Although not shown in FIG. 4, the timing for the transmission 124 to wireless communication device 114, and responsive flash operation of flash device 112, may be similar.

Of course, the aforementioned technique of transmitting radio signals—specifically, a sequence of emission instruction signals that each include timing information as part of the signal, prior to a photographic operation—is only one example of a transmission technique that may be employed by a wireless camera system. Other wireless camera systems may not include a sequence of redundant emission instruction signals, and may instead transmit a single emission instruction signal that includes timing information, and still others may transmit one or more emission instruction signals that do not include timing information.

Moreover, an emission instruction signal is one example of a signal that may be transmitted by a master device of a wireless camera system that characteristically precedes the performance of a selected photographic operation by a predetermined time interval. Some wireless camera systems may employ other wireless signals that characteristically precede a selected operation, which may be recognized as such in a variety of manners, such as by observing the wireless communications that are transmitted prior to a variety of photographic operations and recording such communications in a memory accessible, for example, to a wireless activation device. Thus, when a bridging apparatus receives such a signal, the predetermined time interval may be determined by recognizing the signal, and use an observed time interval from a prior operation of the camera system. Such signals, and corresponding time intervals, may be characteristic of and/or proprietary to certain camera systems and may thus differ among systems or manufacturers, and as such may be preprogrammed into memory to be retrieved according to the wireless camera system in use, and so forth.

A second illustrative example of using a bridging apparatus involves synchronization by using of such a different type of radio signal. In the second illustrative example, a radio signal indicating that a camera shutter button has been half- or fully-pressed by a user operating the camera may be transmitted by the camera, and received by the bridging apparatus 120. Such a signal may characteristically precede a subsequent flash instruction for a flash device to emit a pre-flash emission, and/or the performance of a light measurement operation by the camera, by a predetermined amount of time. The second illustrative example again uses the various photographic devices of the photographic setup 100 of FIG. 1.

Returning to FIG. 3, the example timing chart indicates, on the “camera transmission data” line of the chart, a SW2 signal, which may correspond to a full-press of the shutter button of the camera 104, which may precede the subsequent transmission of a pre-emitting command (captioned as PRE-EMITTING). The “camera operation” and the “flash operation” lines of the timing chart indicate responsive photographic operations of the flash device 106 (i.e., pre-flash emitting) and the camera (i.e., pre-flash measurements) that then follow the pre-emitting command.

As noted above, the delay between transmission of the SW2 signal and the transmission of the subsequent pre-emitting command may be a known characteristic of the camera system 102, or may be recorded from a previously observed photographic operation thereof. As such, upon the receipt of a SW2 signal by bridging apparatus 120, the processing means thereof may recognize the received signal as such, and identify the associated operational command (in this case, the call for the pre-flash emission). The predetermined time interval until the performance of a subsequent camera or flash operation, even though the SW2 signal itself may not contain any timing information, may be determined such as by using an observed time interval. The observed time interval may be one that was used in a prior operation of the camera system that the bridging apparatus observed and recorded, or that has been preprogrammed into memory accessible to the bridging apparatus, and so forth. As in the first illustrative example, the processing means of the bridging apparatus 120 may then calculate the correct timing for transmitting the radio command signal 122 (and/or 124) so that the operation commanded will be performed by a secondary system flash device 110 (flash device 110 and/or flash device 112, via wireless communication device 114) at the appropriate time, such as the time at which the camera is performing a pre-flash operation.

Although not required to all embodiments, some methods of providing a radio bridge between camera systems employing mutually incompatible wireless communication protocols may include wirelessly transmitting a signal to a participant device (such as a camera or other source device) of a first camera system, which is configured to be interpreted by the participant device as if it was sent by a another participant device of the first camera system.

For example, with reference to the example camera system 102 illustrated in FIG. 1, bridging apparatus 120 may be configured to interact with camera 104 by imitating or otherwise acting as a participant device of the camera system 102. In such an example, bridging apparatus 120 may instruct camera 104 that it is another participant device of camera system 102, such as by identifying itself to the camera as another flash device that may be used (in addition to flash device 106) by the camera during image acquisition and other operations. Applicant's co-pending U.S. Patent Application Pub. No. US20100008658, for example, describes the use of pseudo communications provided by a communication device to a camera system participant (such as a flash device or camera), that are interpreted by the camera system participant as if the pseudo communications were actual communications that originated from another camera system participant. Optionally, in some systems, camera 104 may expect a serial number or similar identifying information before it will recognize a device as a participant device in the wireless system of which it is a part. In such systems, bridging apparatus 120 may randomly create an address within an acceptable range to camera 104, may capture an address from an actual participant device of the camera system from a previous or observed operation, a serial number preprogrammed into memory for use with certain models of a camera 104, and so forth.

In these or other suitable manners, bridging apparatus 120 may establish a communication link with camera 104, for example so that the camera thereafter communicates with the bridging apparatus as if it was a participant device (such as a flash device, or another slave device) of wireless camera system 102. On the other hand, bridging apparatus 120 may be configured to provide only minimal reception and/or transmission with camera 104 required to allow photographic devices of other camera systems to cooperate with the devices of the first camera system.

An illustrative method of providing a radio bridge, as described above, includes identifying, in a received signal from a source device of a first camera system, an operational command for a participant device of the first camera system. In examples in which a communication link is established, a source device may have been instructed that, for example, a bridging apparatus is a participant device of the first camera system. For example, bridging apparatus 120 may have instructed primary system camera 104 that the bridging device 120 is another primary system flash device. As such, in some examples of the illustrative method, the operational command associated with the signal transmitted by the source device may be for the participant device of the first camera system that the source device “believes” the bridging apparatus to be.

One example situation in which a communication link may be useful may be explained with reference to FIG. 1. Camera 104 may be configured to gather exposure data related to the subject 126, such as by means of a light metering system that measures incident light on the subject 126. For example, an E-TTL or similar system may be resident in camera 104, in which case the camera may signal one or more pre-flashes, such as to be emitted from flash device 106. The resulting exposure data related to the photographic subject from the pre-flash is read by the light metering system, and the camera may calculate various flash settings based thereon, for example a flash intensity value for the flash device to use during subsequent image acquisition by the camera. Typically, in setups using multiple flash devices for illumination, a pre-flash from each will be requested by the camera, and the camera will correspondingly calculate a flash intensity value for each flash device based on readings from the light metering system. In the photographic setup 100 of FIG. 1, if there is no communication link, an order for a pre-flash emission will be transmitted by the camera 104 to the flash device 106, and passively conveyed to one or both of flash devices 110, 112 by means of bridging device 120, for pre-flash emission synchronous with the (expected) pre-flash emission of flash device 106. If the camera 104 is not expecting pre-flash emissions from flash devices 110, 112, it may consider the pre-flash emissions therefrom to be incident light, and calculate an incorrect setting for emission from flash device 106 for subsequent image acquisition. A user may instead prefer that the camera 104 be instructed that flash devices 110, 112 are available for use during image acquisition, such as to allow the camera's light metering system to be able to calculate accurate flash settings for all of the flash devices that the photographer intends to use. Establishing a communication link, as explained above, may be accomplished by the bridging apparatus instructing the camera that it is a participant device (such as a flash device, or a plurality of flash devices) of the camera system. Thereafter, the camera may transmit instructions to the bridging device as if it was one or more active participant devices in the camera system 102—in this example, a flash device, or a plurality of flash devices.

As such, bridging device 120 may observe, via first radio module 202, primary system communications such as those transmitted between flash device 106 and camera 104, and relay any pertinent or useful information (including, but not limited to, operational commands) to one or more secondary system devices, such as flash devices 110, 112, etc., via appropriate other radio modules (such as 208, 210, etc.). Optionally, processing means 240 of bridging device 120 may re-format, analyze, make decisions based upon, or perform any other useful interaction as a result of, such communications, and further may operate conversely, based on any communications transmitted by the flash devices 110, 112.

In both of the illustrative examples discussed above, the operation of a photographic device employing a given WCP is synchronized with the operation of another photographic device employing a different, incompatible WCP. Although these examples may represent common manners in which a bridging apparatus may be used, the disclosure is certainly not limited to synchronizing operations. As noted above, any manner of communications passed among participant devices of a camera system employing a first WCP may be transmitted, via a bridging apparatus, to one or more photographic devices employing WCPs incompatible with the first WCP. Such communications may be in the form of operational commands not necessarily requiring synchronization, such as various setting commands, requests for data, and so forth, and other communications may simply be status indicators, such as an indication from a flash device that it is charged, acknowledgements of other communications, and so forth.

For example, a participant device of a primary system, such as camera 104, may transmit a communication instructing a flash device, such as flash device 106, to set a light emission output level to a desired level. Such a light emission output level may be encoded in an emission instruction signal, and/or another signal such as a LIGHT AMOUNT SETTING signal (such as indicated in FIG. 3), and so forth. Upon receipt of such a signal by bridging apparatus 120, a radio module of the apparatus may be caused to convey the light emission output level to a secondary system flash device for use during a subsequent operation, and/or bridging apparatus 120 may calculate and transmit a different light emission output level for the target flash device that is based on such a signal.

In examples in which photographic operations are synchronized, such as in the illustrative examples discussed above, the time interval between the receipt of a radio signal from a primary system device, such as a camera or other source device, and the subsequent performance of the photographic operation indicated by the operational command associated therewith may exceed the amount of time needed, such as by the bridging apparatus, for formatting and transmitting a radio command conveying the operational command to a secondary system participant device (and any downstream time required by the participant device to prepare for the operation, for the signal to be further conveyed, such as from a target wireless communication device to the non-wireless device that will ultimately perform the operation, etc.). This may be the case, for example, in settings wherein the data rates between different WCPs linked by the bridging apparatus allow for a radio command signal to be transmitted by the bridging apparatus, such as formatted according a WCP operating according to a fast data rate, in a shorter amount of time than signals are transmitted by the source device (such as if the source device employs a WCP operating according to a comparatively slower data rate).

In one non-limiting example, if a secondary system flash device (e.g., flash device 110 or 112) is charged and prepared to emit a flash, the bridging apparatus may only need a short amount of time, such as less than 1 millisecond, to produce and transmit an appropriate radio command signal for the flash device. In such an example, such as that may involve a flash instruction such as an emission instruction signal, the emission instruction signal may precede image acquisition by the camera by a similar amount of time millisecond, in which case the bridging apparatus may initiate the production of the radio command signal upon (or even while) receiving the emission instruction signal.

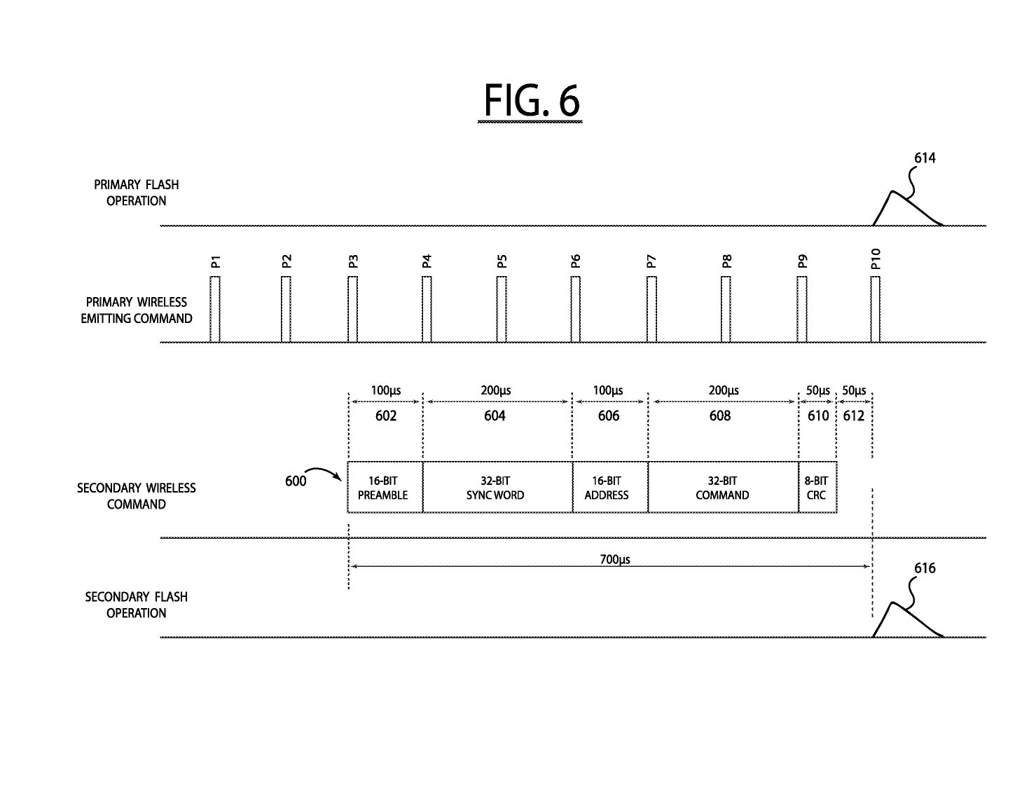

The example timing chart shown in FIG. 6 illustrates this in more detail. In the following description, “primary” refers to a photographic device of a first camera system operating according to a first WCP (such as camera 104 and flash device 106 of camera system 102), whereas “secondary” refers to a participant photographic device operating according to an incompatible WCP (such as flash device 110, or flash device 112) but intended to operate in conjunction with the first camera system, such as by means of a bridging apparatus (such as bridging apparatus 120). The “primary flash operation” line of FIG. 5 thus may indicate the timing of the operation of flash device 106, whereas the “secondary flash operation” line may indicate the timing of the operation of flash device 110, or flash device 112, and so forth.

In FIG. 6, the “primary wireless emitting command” line indicates a sequence of ten emitting instruction signals P1, P2, . . . , P10, such as might be transmitted according to a first WCP by camera 104 as described above, each of which may be formatted according to a packet data structure shown in FIG. 5. Bridging apparatus 120 may receive one or more of the emitting instruction signals, such as P3, identify it as an emission instruction signal, and read the timing information therein. In formatting a corresponding radio signal 600 conveying the emission instruction command, the bridging apparatus 120 may use a packet data structure as indicated on the “secondary wireless command” line of FIG. 6, such as may include a preamble 602, a synch word or words 604 (such as to alert a receiving radio that a valid packet is arriving), an address 606 (which may correspond to an intended recipient), a command 608 corresponding to the operational command read from the emission instruction signal, and a CRC or checksum 610. Upon receipt of the radio signal 600, bridging apparatus 120 may be configured to require an interval of time 612 for processing. The total span of time for transmission of radio signal 600 in this example is shown to be 700 microseconds. Bridging apparatus 120 thus may be configured to prompt a suitable radio module to begin transmission of the radio signal 700 microseconds prior to the expected emitting event 614 of the primary flash device, so that the secondary flash operation 616 occurs simultaneously. Based on the timing information of the emitting instruction signal, the bridging apparatus 120 may begin transmission accordingly. For example, P3 may indicate that the event is to take place 700 microseconds later, in which case bridging apparatus 120 may transmit radio signal 600 upon receipt of P3. Bridging apparatus 120 may be configured to ignore other emitting instruction signals after initiating transmission, may be configured to wait an interval of time if the emitting instruction indicates a greater amount of time than 700 microseconds, may transmit an acknowledgment signal otherwise, etc.

In other examples, such as that may involve a SW2 or similar wireless signal, such a signal may precede the subsequent camera operation by an interval greater than 1 millisecond, such as several milliseconds, or even several tens or hundreds of milliseconds. Accordingly, once the time interval is determined from such a signal, the bridging apparatus may allow an appropriate portion of the time interval to elapse before transmitting the radio command signal to the target photographic device, to synchronize the operation thereby with the camera operation.

Similarly, processing means of a bridging apparatus may calculate the proper portion of the time interval to elapse before transmitting a radio command signal to the target secondary system device based on any received wireless signal that may be recognized as preceding a selected photographic operation by a predetermined amount of time. Such signals may include one of those indicated on the “camera transmission data” lines of the example timing charts shown in FIGS. 3 and 6 (e.g., SW1, SW2, PRE-EMITTING, LIGHT AMOUNT SETTING, EMITTING COMMANDS such as P1, P2, . . . , P10, etc.), those indicated on the “flash transmission data” lines of the example timing charts (e.g., acknowledgment signals designated as “Ack,” etc.), other commands transmitted in the wireless camera system, such as beacon signals, and so forth, and any combination thereof.

Conversely, in some examples, including examples in which photographic operations are to be synchronized, a fairly lengthy conversation, preparation, communication, etc., may be required from bridging apparatus 120 to a target photographic device of the second camera system, such as flash device 110, flash device 112 via wireless communication device 114, etc., such as might be due to a slower data rate of the second WCP employed by the target photographic device as compared to the first WCP employed by the first system, charge time needed by the flash device 110, 112, time needed by the wireless communication device 114 to encode an optical or electrical signal perceptible to flash device 112, and so forth. Such a duration of time may be greater than the time duration expected for the corresponding event to be carried out according to the first WCP.

In some camera systems, a participant device (such as camera 104) may wait at certain points in a communication exchange for an acknowledgement signal from another participant device (such as flash device 106). In such camera systems, it may be possible to cause the participant device waiting for an acknowledgement signal to delay an event that would otherwise be triggered by receiving and acknowledgement signal, by delaying the transmission of the expected acknowledgment signal. A bridging apparatus may use the additional time to complete the communication process with the target photographic device, or to allow a process to be carried out within the second camera system (for example, allowing some time for a capacitor to charge to a new level before allowing an image acquisition operation to be performed by a camera of the first camera system, etc.).

With reference to the example timing chart of FIG. 3, a SW2 signal may be transmitted to bridging apparatus 120 from camera 104. It may be known, for example according to the operational system resident in camera 104, that the camera will wait up to a given time interval for an acknowledgement signal, such as indicating charge completion, to be returned by flash device 106 (see “flash transmission data” line). In the absence of an acknowledgement, the camera 104 may simply transmit another SW2 signal after the time interval has elapsed. In this example, the bridging apparatus 120 upon receiving the SW2 signal, may initiate communication with one or more target photographic devices (e.g., flash devices 110, 112). After communication is complete, or after otherwise waiting an interval in which it may be expected that the one or more target photographic devices are prepared and ready to perform the requested operation, bridging apparatus 120 may transmit, such as via radio module 202, the acknowledgment signal expected by camera 104, whereupon camera 104 may proceed to continue an operational sequence (such as requesting a pre-flash, etc.).

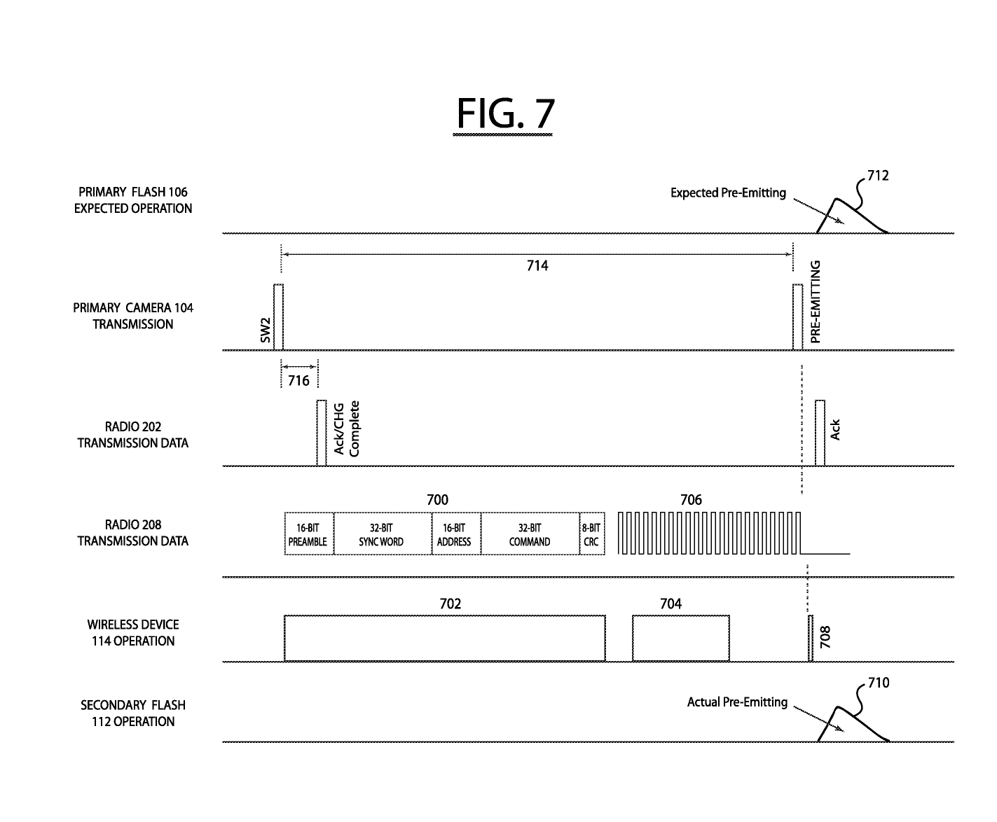

FIG. 7 illustrates an example timing chart showing aspects of such a process in greater detail, with reference to the photographic setup 100 of FIG. 1. On the “primary camera 104 transmission” line, signal SW2 is transmitted. Upon receiving SW2 via radio module 202 (employing the first WCP), bridging apparatus 120, via radio module 208 (employing a secondary WCP) formats and transmits a radio signal 700 which, when received (during time interval 702) by a secondary wireless device (such as wireless communication device 114) may prepare (during time interval 704) the device to ready for an event, such as a pre-emitting event. After transmitting radio signal 700, radio module 208 of bridging apparatus 120 may begin transmitting a quickly modulating signal 706 that is observable via radio receiver to the secondary device (in this example, wireless communication device 114). When bridging device 120, via radio module 202, observes a PRE-EMITTING command from the camera 104, bridging device 120, via processing means 240, may cause radio module 208 to halt the modulation of the signal 706. The secondary device observes the quick modulation has stopped or has remained constant for an amount of time, which may trigger the secondary device to send an emission signal 708 to a flash device (such as flash device 112), which may carry out an emitting operation 710 synchronized with the expected emitting operation 712 of the primary flash device 106. Depending on whether a communication link has been established, camera 104 may have expected emitting operation 710 in addition to emitting operation 712.

However, as noted above, in some circumstances, such as when communicating with certain equipment and/or according to a WCP requiring a longer packet than signal 700, or a slower data rate, the interval of time 714 between (in this example) SW2 and the PRE-EMITTING signal may not be long enough to allow preparation and processing of the necessary communications to be achieved in sufficient time for the secondary flash device to be ready to synchronize a emitting operation with the expected emitting operation 712 of the primary flash device 106. In such circumstances, bridging apparatus 120 may delay an operation of the primary system by transmitting a intentionally delayed acknowledgement signal, or, in other words, by increasing the interval of time 716, which in turn increases the time interval 714 before the expected operation occurs.

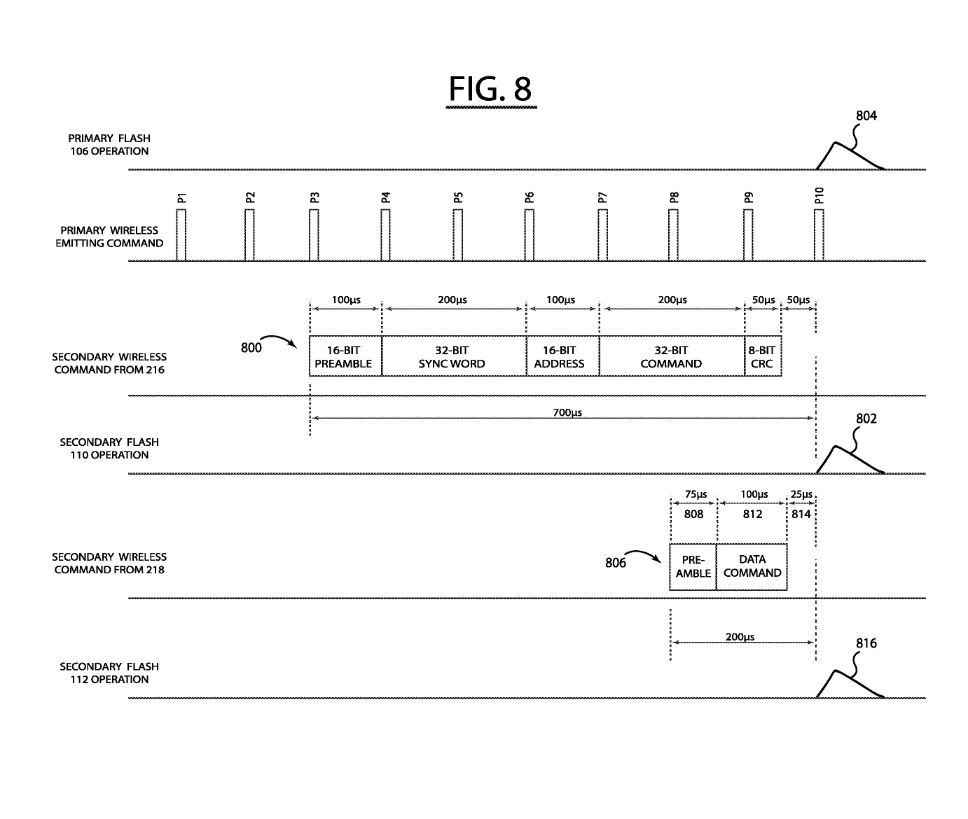

In some applications, such as suggested in FIG. 1, a user may wish to bridge a wireless camera system 104 with two or more other photographic devices (or camera systems), which respectively may employ two or more WCPs that are not only incompatible with the first WCP, but are incompatible with each other. In the example photographic setup 100 shown in FIG. 1, wireless-enabled flash device 110 and non-wireless flash device 112 (via wireless communication device 114) may employ a second and a third WCP, respectively, but may be bridged with each other and with the first camera system 104 by means of bridging device 120. FIG. 8 shows a timing chart with an example synchronization sequence for such an application. Somewhat similar to that shown in FIG. 6, the “primary wireless emitting command” line indicates a sequence of ten emitting instruction signals P1, P2, . . . , P10, such as might be transmitted according to a first WCP by camera 104 as described above, each of which may be formatted according to a packet data structure shown in FIG. 5. Bridging apparatus 120, such as via first radio module 202, may receive one or more of the emitting instruction signals, such as P3, identify it as an emission instruction signal, and read the timing information therein.

As with FIG. 6, it may be characteristic of the second WCP employed by radio module 208 of bridging apparatus 120 (and wireless-enabled flash device 110) to use a radio signal 800, formatted as the packet shown on the “secondary wireless command from 216” line, requiring a time interval of 700 microseconds to prepare and transmit, to ensure emitting event 802 (on the “secondary flash 110 operation” line) of the flash device 110 will occur coincident with the emitting event 804 of the primary flash 106. Somewhat analogously, it may be characteristic of the third WCP employed by radio module 210 of bridging apparatus 120 (and non-wireless flash device 112, via wireless communication device 114) to use a radio packet 806 that is formatted differently, such as by including a different packet format, requiring a different amount of time to transmit, etc. In the example shown in FIG. 8, on the “secondary wireless command from 218” line, radio signal 806 is shown as a packet that includes a preamble 808 and a data command 810, and that allows a shorter following time interval 812 for processing, requiring a total span of time of 200 microseconds for transmission. As with radio signal 800, bridging apparatus 120, such as via processing means 240, may be configured to prompt radio module 210 to initiate transmission of the signal based on the timing information read from one or more received emission instruction signals P1, P2, . . . , P10, as appropriate to synchronize emitting event 816 (on the “secondary flash 112 operation” line) of the flash device 112 with the emitting event 804 of the primary flash 106.

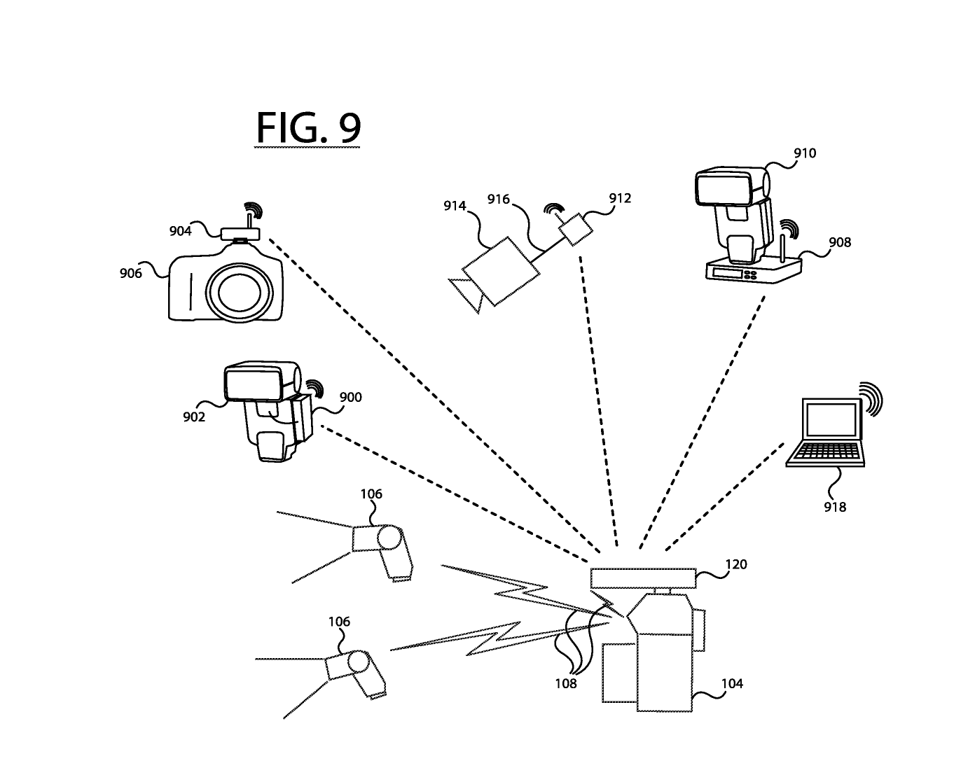

FIG. 9 is a schematic diagram illustrating a variety of example connections and communications that may be achieved with a bridging device such as bridging device 120. In FIG. 9, bridging device 120 is shown to be configured to be removably connected with a photographic device, such as camera 104 of a first camera system 102, via a hotshoe connection. As is standard with such connections, the hotshoe connection may provide a serial data communication path, which may be utilized for communication between the bridging apparatus instead of or in addition to communication via radio signals. Optionally, the bridging device may connect to the camera 104 by any other suitable means, such as via a USB port, a connector or cord, and so forth. So connected, bridging device may communicate with other participant devices of the first WCP, such as flash devices 106, or even camera 104, directly via radio signals 108. With respect to camera 104, the bridging apparatus 102 may instruct the camera that it is a compatible flash device, such as flash device 106, thus initiating a communication link with the camera 104. Bridging apparatus 102 may optionally carry out various communication and/or bridging operations with various secondary wireless-enabled equipment, including but not limited to: a wireless communication device 900 configured to optically communicate with a flash device 902 (which in turn may be responsive to pulsed light signals emitted by the device 900), a wireless communication device 904 that is coupled to another camera 906 via a hotshoe connector or otherwise, a wireless communication device 908 that is coupled to a flash device 910 via a hotshoe connector, a wireless communication device 912 that is coupled to a studio lighting unit 914 via a cord 916 or otherwise, a personal computer or laptop 918, and so forth. The wireless communications used by bridging apparatus 102 to communicate with the various wireless-enabled devices listed above, although shown as simple dashed lines, may employ one or more different WCPs as suitable for the various devices (and as such may be formatted compatibly with radio signals 108, 124, 126, or otherwise), and may be unidirectional or bi-directional.

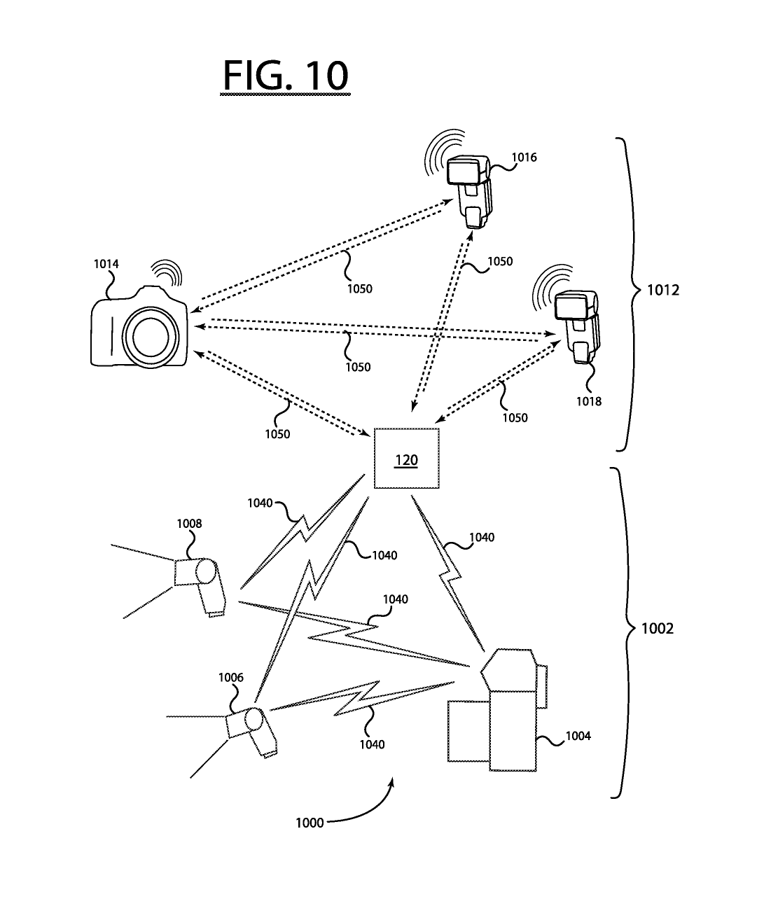

FIG. 10 illustrates one manner in which a bridging apparatus, such as bridging apparatus 120, may be used in order to bridge or otherwise translate communications between two camera systems employing mutually incompatible WCPs, such as in a setting in which photographic equipment produced by one manufacturer employs a proprietary WCP that is incompatible with, for example, any equipment produced by competing manufacturers, or equipment produced by a specific competitor, and so forth. According to the concepts and methods discussed above, a bridging apparatus may allow components of non-compatible systems to cooperate, or otherwise interact, in a similar manner as if they all employed the same WCP.

In FIG. 10, a photographic setup 1000 includes a first camera system 1002, the wireless-enabled participant devices of which are camera 1004 and flash devices 1006 and 1008, all of which employ a first WCP. Second camera system 1012 includes wireless-enabled participant devices camera 1014 and flash devices 1016 and 1018, all of which employ a second WCP, with the first and second WCPs being mutually incompatible with each other. Bridging device 120 operates to facilitate communications and operations between the otherwise incompatible camera systems.

For example, camera 1004 communicates with flash devices 1006 and 1008 by means of radio signals 1040, which are formatted according to the first WCP. Further, camera 1004 may communicate with bridging device 120, such as if the bridging device has established a communication link with the camera 1004, such that the camera “believes” that it is communicating with another participant device (for example, another flash device similar to flash devices 1006 and/or 1008) of the first camera system. Analogously, camera 1014 communicates with flash devices 1014 and 1016 by means of radio signals 1050, which are formatted according to the second WCP, and may further communicate with bridging device 120, which it may “believe” is another participant device (for example, another flash device similar to flash devices 1016 and/or 1018) of the second camera system. Bridging device 120 may employ one or more radio modules in order to transmit and receive the various radio signals 1100, 1102, as well as processing means 240 to relay or otherwise convey operational commands and other information from one camera system to the other.

Further, bridging device 120 may communicate with one or more of the flash devices 1006 and 1008, and/or one or more of flash devices 1016 and 1018, by identifying itself to the flash devices as a participant device of their respective camera systems. For example, bridging device 120 may identify itself to flash device 1006 that it is another camera of the first camera system. Or, bridging device 120 may identify itself to flash device 1006 that it is camera 1004 of the first camera system. Other possibilities include the bridging device 120 identifying itself to flash device 1006 as, or otherwise mimicking, a camera with similar functionality to camera 1004, a flash device with similar or different functionality than flash 1006, multiple photographic devices, and so forth. Similarly, bridging device 120 may identify itself to camera 1004 as flash device 1006, another flash device with similar functionality, another camera with similar functionality to camera 1004, multiple photographic devices, and so forth. In these and other manners, bridging device 120 may synchronize operations of any of the components of either camera system with those of any other components. In one example of such synchronized operations, bridging device 120 may translate and/or otherwise facilitate communications between camera 1004 and flash devices 1016, 1018, such that the flash devices are caused to emit light (such as in an emitting operation for image acquisition, a pre-emitting operation for exposure calculation, etc.) in a manner synchronized with the operation of camera 1004 and observable and/or measurable by camera 1004. In a similar manner, bridging device 120 may allow emitting operations of flash devices 1006, 1008 to be synchronized with a camera operation of camera 1014.

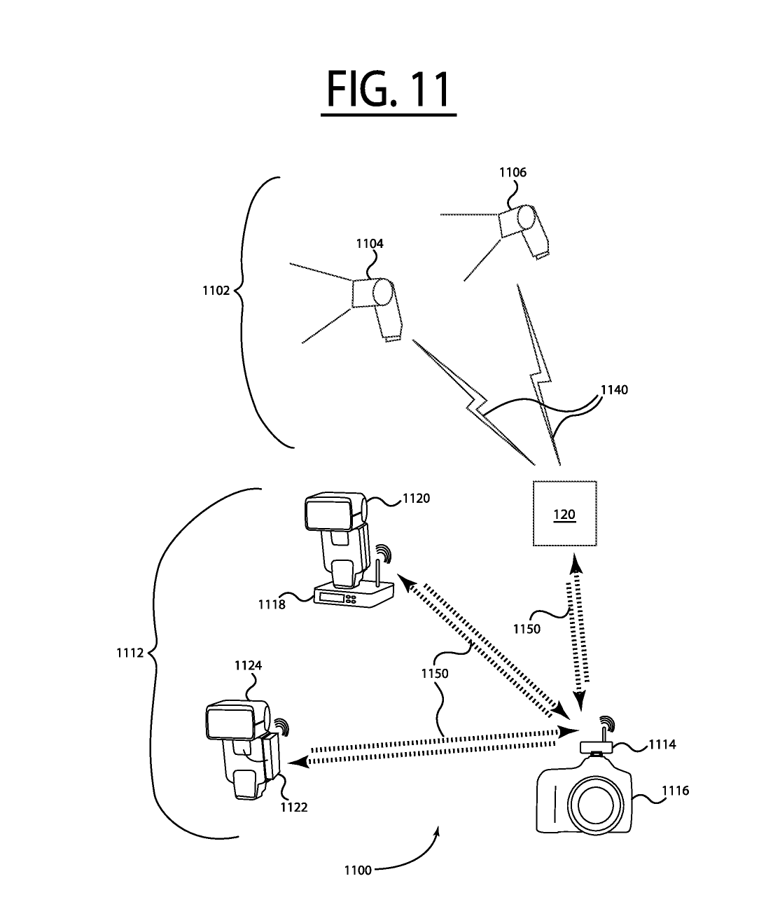

FIG. 11 illustrates another manner in which a bridging apparatus, such as bridging apparatus 120, may be used in order to bridge or otherwise translate communications between two camera systems employing mutually incompatible WCPs. In FIG. 11, a photographic setup 1100 includes a first camera system 1102 having two wireless-enabled flash devices 1104, 1006, and a second camera system 1112 having the following wireless-enabled participant devices: a wireless communication device 1114 that is coupled with a non-wireless camera 1116 via a hotshoe connection, a wireless communication device 1118 that is coupled with a flash device 1120 via a hotshoe connection, and a wireless communication device 1122 that is coupled with a second flash device 1124. First camera system communicates by means of radio signals 1140, and second camera system communicates by means of radio signals 1150. Bridging device 120 operates to facilitate communications and operations between the otherwise incompatible WCPs employed, respectively, by the two camera systems, such as by communicating with flash devices 1104, 1006, as if it was a wireless-enabled camera device employing the first WCP, and thus a participant device of the first camera system.

Further, one or more of the wireless communication devices (1114, 1118, 1122) used with the various participant devices of the second camera system may also mimic another device. As noted above, this may be accomplished by means of pseudo communications or other methods, examples of which are disclosed in Applicant's aforementioned US20100008658. For example, wireless communication device 1114 may identify itself to camera 1116 as a flash device, and thus may receive electrical signals from the camera as might be sent to a flash device, and may in turn respond to the camera with signals similar to, or exactly matching, signals that may otherwise be expected by the camera from an attached flash.

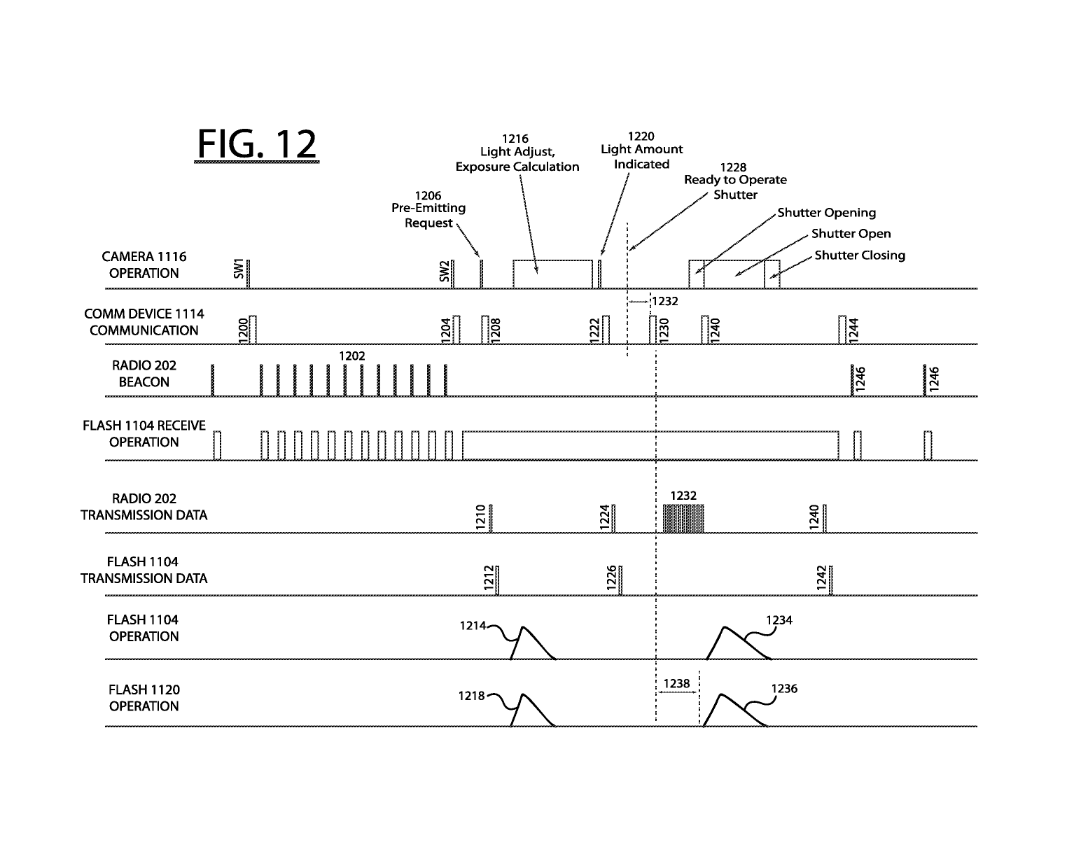

FIG. 12 shows a simplified timing plot illustrating an example sequence of communications and operations that might take place in the photographic setup 1100.

Camera 1116 may provide an indication to wireless communication device 1114, for example via the hotshoe connection, of a first switch operation “SW1,” which may indicate a half-press of the shutter button of camera 1116. Device 1114 may respond by transmitting a radio signal or signals 1200 (which may be indicated in FIG. 11 as one of radio signals 1150), which may be received by a radio module of bridging device 120, for example second radio module 208. In response to receiving signal 1200, bridging device 120 may, for example via first radio module 202 or another appropriate radio module, begin emitting a beacon 1202, or may change the timing of the beacon to a faster or slower timing. Beacon 1202 may be formatted and transmitted according to a first WCP, and received, for example, by flash device 1104, to prepare flash device 1104 for operation. In this example, bridging device 120 may have already established a communication link with one or both of the flash devices of the first camera system; as such, the beacon may be recognized by flash device 1104 as a beacon signal indicating a preparation for flash operation.

Continuing the example sequence, second switch operation “SW2” may be indicated by a camera 1116 to wireless communication device 1114, for example via the hotshoe connection, corresponding to a full-press of the shutter button of the camera. In response, device 1114 may transmit a signal 1204, which is received by bridging device 120. The camera 1116 may then indicate a request 1206 for a pre-emitting operation. The wireless communication device 1114 may acknowledge the request by replying with pseudo communications to the camera 116, and further may transmit a signal 1208 responsive to the request 1206, which is also received by bridging device 120. In response to receiving the signal 1208, bridging device 120, such as via radio module 202, may transmit a corresponding signal 1210 formatted according to the first WCP, and thus detectible to flash device 1104. Upon receipt of signal 1210, flash device 1104 may transmit an acknowledgement 1212 back to the bridging apparatus 120 and/or to another camera. Flash device 1104 may subsequently perform an emission operation, such as pre-emitting operation 1214, and the camera 1116 may perform a light adjustment and exposure calculation, indicated on the “camera 1116 operation” line at 1216.

Employing the concepts and methods above, it is possible to optionally cause an emission operation, such as pre-emitting operation 1218, such as by another flash device, such as one or both flash devices 1120, 1124 of the second camera system, to occur more or less at the same time or even substantially in place of pre-emitting operation 1214. Such a pre-emitting operation 1218 may be in response to, or timed according to, or otherwise based upon, signal 1204, or signal 1208, which, although may have been directed from wireless communication device 1114 to bridging device 120, may have been also or instead observed or received by flash device 1120 (such as via wireless communication device 1118), or flash device 1124 (via wireless communication device 1122), prompting one or more of the flash devices to perform a pre-emitting operation, such as pre-emitting operation 1218 in FIG. 12.

In any case, the sequence may proceed with camera 1116, after performing an exposure calculation and communicating, at 1220, a “light amount indicated” signal via the hotshoe to the wireless communication device 1114, which may acknowledge the signal, such as by means of a suitable pseudo communication. Meanwhile, device 1114 may transmit a signal 1222, formatted according to the second WCP, indicating the light amount indicated by the camera 1116. Bridging apparatus 120 may receive the signal 1222, for example via second radio module 208, and then transmit a corresponding signal 1224 conveying the light amount indicated as calculated by the camera at 1220. Signal 1224 may be received by one or both flash devices 1104, 1106 of the first wireless camera system, which may then set a light emission level based on the signal and further transmit an acknowledgement 1226 back to the bridging device 120. Optionally, the bridging device 120 may in turn transmit an acknowledgment back to wireless communication device 1114, such as to indicate that the one or more flash devices have been prepared, whereupon the wireless communication device may relay the indication to the camera 1116 via the hotshoe. At this point (indicated in FIG. 12 at 1228), the flash system is ready to perform emission operations for image acquisition by the camera.

As such, in response to a signal from camera 1116, wireless communication device 1114 may send a signal 1230, formatted according to the second WCP, indicating that the shutter of camera 1116 is open or that an imaging sensor is active, or that the shutter is in the process of opening, or is expected to open, or that the imaging sensor is expected to become active, in the immediate or near future. In some camera systems, camera 1116 may be expected to reach a ready state, such as at 1304, based on some data that passes between camera 1116 and the wireless communication device 1114, or based on some interval of time from another communication (for example, the “light amount indicated” signal 1220), wherein the interval of time may be characteristic to the camera type or model, etc. Wireless communication device 1114 may accordingly wait an interval of time 1232 before transmitting signal 1230, the timing of which may determine the time at which an emitting command may be transmitted (and, ultimately, the time at which a main emitting operation will take place).

Signal 1230 transmitted by wireless communication device 1114 may be formatted according to the second WCP, and received by a corresponding radio module of bridging device 120. In response, bridging device 120 may immediately, or upon the lapse of an interval of time following the receipt of signal 1230, transmit an emitting command 1232, which may be a single command, or multiple commands such as a sequence of emitting commands. In the latter case, bridging device may include a generation unit, such as processing means 240, configured to insert different timing information in each of the sequence of emitting commands depending on its place in the sequence, such as so that each indicates a (successively shorter) time interval until the emitting operation is to take place, and transmit the sequence of signals according to a timing protocol, such as one emitting command every 100 microseconds. The format of each emitting command in a sequence may be as shown in FIG. 5, or otherwise as suitable to the WCP employed.

As may be disclosed, for example, in US20100202767 of Shirakawa, a wireless-enabled flash device such as flash device 1104 or 1106, may receive one of the emitting commands 1232 and perform a main emitting operation 1234 in response thereto.

In some cases, camera 1116 may provide an indication only very shortly before, or even during, the operation of a shutter or the activation of an imaging sensor (such as in a shutterless camera), such that there may be insufficient time for a comparatively lengthy sequence of an emitting command 1232 to be transmitted, considering also that a preceding signal 1230 may also need to be transmitted by wireless communication device 1114 and wholly or at least partially received by bridging apparatus 120 before transmission of emitting command 1232 may be initiated. In such cases, it may be preferable to transmit a shorter sequence of emitting commands, or even a single emitting command 1232, which may include timing information to cause a flash device to activate substantially immediately or very shortly after receiving such an emitting command.

As with the pre-emitting operation, it is possible to optionally cause an emission operation, such as a main emitting operation 1236, such as by another flash device, such as one or both of the flash devices 1120, 1124 of the second camera system, to occur more or less at the same time or even substantially in place of main emitting operation 1234. For example, flash device 1120 (such as via wireless communication device 1118), or flash device 1124 (via wireless communication device 1122), may also or instead have observed signal 1230, although the signal may have been directed from wireless communication device 1114 to bridging device 120. A processing functionality of either flash device, or of one or both of the wireless communication devices coupled thereto, may wait an interval of time 1238 before activating or causing the corresponding flash device to operate and perform a main emitting operation 1236; such an interval may be based on received or observed radio signal 1230, or any other appropriate signals. Indeed, radio signal 1230 may in some cases actually indicate the interval of time before a main emitting operation should be performed. As another possibility, time interval 1238 may be based on the transmission of a signal 1240 by the wireless communication device 1114 upon observing a signal from the camera 1116 indicating that the shutter is open, that an image is being captured, etc., such as indicated on the “camera 1116 operation” line of FIG. 12. In any case, such as responsive to signal 1240 or otherwise after a time interval 1238, one or more of the flash devices may perform a main emitting operation, such as main emitting operation 1236, which may be coincident with (or instead of) main emitting operation 1234.

Following a main emitting operation, bridging apparatus 120 may transmit, for example via radio module 202, one or more signals 1240 to flash devices 1104, 1106 indicating an end of operation, which may prompt one or the flash devices to respond with an acknowledgement 1242, such as to indicate a proper operation of the flash device(s). The acknowledgement 1242 may be received by bridging device 120, for example via first radio module, and conveyed, for example via second radio module (and formatted according to the second WCP), as signal 1244 to the wireless communication device 1114. At this point an indication may be provided to a user of camera 1116, such as via a graphical display on the camera or the wireless communication device, that the flash device(s) properly operated. Optionally, wireless communication device 1114 may transmit a signal to bridging device 120 that it may resume sending a beacon 1246, for example via first radio module 202 (and formatted according to the first WCP). Also, or alternatively, bridging device 120 may predict, for example via processing means 240, an end of operation based on previous sent or received signals, and independently begin transmitting beacon 1246. Beacon 1246 may be transmitted at the same, or a different, rate as compared with beacon 1202, which may have the effect of maintaining a flash device, such as flash device 1104 or 1106, in a more ready condition, such as to allow the flash device to respond more quickly in future operations.

In the foregoing disclosure, the present invention has been described with reference to specific illustrative embodiments, methods, processes, and other examples, and selected variants thereof. It will be apparent to those skilled in the art that various modifications and changes may be made, however, without departing from the scope of the present invention as set forth in the claims. The specification and drawings are provided for illustrative purposes, rather than to restrict or limit any aspect of the scope of the disclosure. The present invention is intended to embrace all such alternatives, modifications and variances that fall within the scope of the appended claims.

For example, the steps, actions, or events recited in any of the methods or processes disclosed and/or claimed herein may be executed in any order and may not be limited to the specific order presented. Additionally, components and/or elements presented and/or claimed in any apparatus, device, component herein may be assembled or otherwise operationally configured in a variety of permutations and accordingly may not be limited to the specific configuration(s) presented.

Further, benefits, other advantages, and solutions to problems or challenges may be described herein with regard to particular embodiments, however, any such benefit, advantage, solution, or any element that may enhance or cause any particular benefit, advantage, or solution to occur are not to be construed as critical, required, or essential features or components of the invention, nor should the claims be construed as exclusively addressing such benefits, advantages, or solutions.

I claim:

1. A method of providing a radio bridge between a first camera system employing a first wireless communication protocol and a second camera system employing a second wireless communication protocol, wherein the first and second wireless communication protocols are mutually incompatible, the method comprising:
receiving one or more radio signals transmitted by a source device of the first camera system and formatted according to the first wireless communication protocol;
identifying, from the one or more received radio signals, an associated operational command for a participant device of the first camera system;
formatting, according to the second wireless communication protocol, a radio command signal conveying the operational command; and
transmitting the radio command signal to a participant device of the second camera system.

2. The method of claim 1, wherein identifying the operational command includes reading the operational command from the one or more received radio signals.

3. The method of claim 2, wherein the operational command includes timing information indicating a predetermined time at which the operation is to be performed;
wherein identifying the operational command includes reading the timing information included in the operational command; and
wherein the method further includes calculating, based on the timing information, appropriate timing for transmitting the radio command signal so that the operation will be performed by the participant device of the second camera system at the predetermined time.

4. The method of claim 1, wherein identifying the operational command includes recognizing at least one of the received radio signals as a radio signal that precedes the subsequent transmission of the operational command by a characteristic time interval.

5. The method of claim 4, further including calculating, based on the time interval, appropriate timing for transmitting the radio command signal so that the operation will be performed at the predetermined time.

6. The method of claim 5, further including delaying the subsequent transmission of the operational command by at least an amount of time sufficient to transmit the radio command signal.

7. The method of claim 6, wherein delaying the subsequent transmission of the operational command includes transmitting a delayed acknowledgement signal to the source device.

8. The method of claim 4, wherein the source device of the first camera system is a camera, and wherein the one or more radio signals include a radio signal indicating that the shutter button of the camera has been pressed.

9. The method of claim 1, wherein the operational command includes one or more of a flash operation command, a camera operation command, and a request for data.

10. The method of claim 1, wherein receiving one or more radio signals is performed by a first radio module compatible with the first wireless communication protocol, and wherein transmitting the radio command signal is performed by a second radio module compatible with the second wireless communication protocol.

11. The method of claim 1, wherein the radio command signal is configured to cause the participant device of the second camera system to relay the operational command conveyed therein to a slave device adapted to perform the operation upon receipt of the command.

12. The method of claim 1, wherein the participant device of the second camera system includes one or more of a wireless-enabled slave device adapted to perform the operation, and a wireless-enabled communication device adapted to emit communications perceptible to a non-wireless slave device adapted to perform the operation.

13. The method of claim 1, wherein the operational command is a first operational command, and wherein the method further includes:
identifying, from the one or more received radio signals, a second associated operational command for a participant device of the first camera system;
formatting, according to a third wireless communication protocol that is mutually incompatible with the first and second wireless communication protocols, a radio command signal conveying the second operational command; and
transmitting the radio command signal to a participant device of a third camera system employing the third wireless communication protocol.

14. A method of providing a radio bridge, the method comprising:
establishing a communication link between a first participant device of a first camera system that employs a first wireless communication protocol and a communication device that is not a participant device of the first camera system by identifying the communication device to the first participant device as a second participant device of the first camera system;
receiving, by the communication device, one or more radio signals transmitted by the first participant device and formatted according to the first wireless communication protocol;
identifying, from the one or more received radio signals, an associated operational command for the second participant device;
formatting, according to a second wireless communication protocol mutually incompatible with the first wireless communication protocol, a radio command signal conveying the operational command; and
transmitting, by the communication device, the radio command signal to a participant device of a second camera system that employs the second wireless communication protocol.

15. The method of claim 14, wherein establishing a communication link includes transmitting, by the communication device, a radio signal formatted according to the first wireless communication protocol and conveying identifying information substantially similar to that which would be provided by a second participant device of the first camera system, to the first participant device.

16. The method of claim 14, wherein the participant device of the second camera system includes one or more of a wireless-enabled photographic device adapted to perform the operation, and a wireless-enabled communication device adapted to emit communications perceptible to a non-wireless photographic device adapted to perform the operation.

17. The method of claim 14, further including establishing a communication link between the communication device and a participant device of the second camera system by identifying the communication device to the participant device of the second camera system as a second participant device of the second camera system.

18. A bridging apparatus for use with a camera system, comprising:
a first radio module configured to receive radio signals formatted according to a first wireless communication protocol and transmitted by a source device of a first camera system that employs the first wireless communication protocol; and
circuitry adapted to:
associate one or more received radio signals with a corresponding operational command for a participant device of the first camera system;
format, according to a second wireless communication protocol incompatible with the first wireless communication protocol, a radio command signal conveying the operational command; and
cause a second radio module compatible with the second wireless communication protocol to transmit the radio command signal to a participant device of a second camera system that employs the second wireless communication protocol.

19. The bridging apparatus of claim 18, further including one or more of the second radio module, and a port configured to couple with the second radio module.

20. The bridging apparatus of claim 18,
wherein the first radio module is further configured to transmit radio signals formatted according to the first wireless communication protocol; and
wherein the circuitry is further adapted to:
format, according to the first wireless communication protocol, a radio identification signal identifying the communication device as a participant device of the first camera system; and
cause the first radio module to transmit the radio identification signal to the source device.
